(19) United States
(12) Patent Application Publication
(10) Pub. No.: US 2019/0213946 A1
(43) Pub. Date: Jul. 11, 2019

(54) LED MODULE, LED DISPLAY SCREEN, AND DISPLAY SYSTEM

(71) Applicant: Dongguan Darzune Optotech Co., Limited, Dongguan (CN)

(72) Inventors: Ligang Zhao, Dongguan (CN); Guangming Song, Dongguan (CN)

(21) Appl. No.: 16/299,171

(22) Filed: Mar. 12, 2019

Related U.S. Application Data
(63) Continuation-in-part of application No. 15/873,844, filed on Jan. 17, 2018.

(30) Foreign Application Priority Data
Oct. 18, 2017 (CN) 201710991776.8

(51) Int. Cl. G09G 3/32; G09G 3/20; G09G 5/00

(52) U.S. Cl. CPC G09G 3/32; G09G 3/2096; G09G 2320/0233; G09G 2370/12; G09G 5/005

(57) ABSTRACT

The present invention relates to the field of display technologies, and provides an LED module comprising an LED array and a control circuit for driving the LED array to work. The LED array comprises multiple rows of LED units, each row of the LED units comprising multiple LED pixels integrating an red light-emitting grain, a blue light-emitting grain and a green light-emitting grain. The LED array is arranged in such a pattern that alternate rows aligned with each other, in which LED pixels of the same sequence number in adjacent two rows of the LED units are deviating one another in a vertical direction, thereby forming a structure in which the LED pixels in each row of the LED units is arranged deflecting from each LED respective LED pixels in an adjacent row of the LED units.

### CROSS-REFERENCE TO RELATED APPLICATION

The present application is a continuation-in-part application of U.S. patent application Ser. No. 15/873,844 filed on Jan. 17, 2018, which claims priority to Chinese Patent Application No. 201710991776.8 filed on Oct. 18, 2017. The contents of all the above are hereby incorporated by reference herein as if set forth in its entirety.

### TECHNICAL FIELD

The present invention relates to the field of LED display technologies, and particularly to an LED module, a LED display screen, and a display system.

### BACKGROUND

The LED layout in an existing LED display is typically in a matrix mode, as shown in FIG. 1.

A moire pattern as shown in FIG. 2 is formed when an existing LED display is shot by using a camera, a camcorder, or other picture acquisition and video recording devices, due to the spatial interference between the pixel layout in the LED display screen and the pixel layout in an image acquisition sensor of the picture acquisition and video recording device.

In the prior art, the method for eliminating the moire effect associated with the LED display screen generally comprises providing a layer of low-pass filter film before the LED display screen or a lens of an image acquisition device. By means of such a method, the high-frequency details are filtered off from an image, such that no conditions for producing beat principle exist between the array of the LED display screen and the image acquisition device, and thus no spatial interference occurs, thereby inhibiting the moire effect. However, this method filters off the high-frequency detail information from the image, leading to a considerably decreased sharpness and a severely impaired quality of the image.

### SUMMARY

In view of the technical problem existing in the prior art, the present invention provides an LED module, an LED display screen, and a display system, so as to solve the problem of moire pattern occurring when an existing LED display screen is shot by using a picture acquisition and video recording device.

The present invention is accomplished as follows. An LED module is provided, which comprises an LED array and a control circuit for driving the LED array to work. The LED array comprises a plurality of rows of LED units, and each row of the LED units comprises a plurality of LEDs disposed in sequence.

The LED array is arranged in such a pattern that alternate rows are aligned with each other, in which LEDs of the same sequence number in all the odd rows of the LED units are aligned in a same vertical direction, LEDs of the same sequence number in all the even rows of the LED units are aligned in a same vertical direction, and LEDs of the same sequence number in adjacent two rows of the LED units are deviating one another in the same vertical direction, thereby forming a structure in which LEDs in each row of the LED units are arranged deflecting from respective LEDs in an adjacent row of the LED units.

The control circuit is configured to convert a received serial digital signal into a parallel display signal by which the LEDs is controlled to on/off.

Further, a connecting line between LEDs of the same sequence number in adjacent two rows of the LED units is at 45 degrees with respect to the vertical direction.

Further, the control circuit comprises a drive module and an interface module, in which the interface module is configured to receive a serial digital signal and a DC power signal for supplying power to the drive module; and the drive module is connected to the interface module and a pin of each LED, and configured to convert the received serial digital signal into a parallel display signal by which the LEDs is controlled to on/off.

The present invention further provides an LED display screen, which comprises a plurality of LED modules described above and a plurality of receiving cards, in which the receiving cards are connected to the a plurality of LED modules, and configured to receive a display signal, convert the display signal into a serial digital signals, and transmit the serial digital signal to the connected LED modules; and the LED module is configured to display according to the serial digital signal.

The present invention further provides a display system, which comprises the LED display screen and a signal source unit, in which the signal source unit is configured to transmit a display signal to the LED display screen; and the LED display screen is configured to display a corresponding content according to the display signal.

Further, the signal source unit comprises a video signal source and a transmission controller, in which the video signal source is configured to provide a video signal of a preset video format; and the transmission controller is configured to convert the video signal into a display signal capable of being recognized and displayed by the LED screen, and transmit the display signal to the LED display screen.

Compared with the prior art, the present invention has the following beneficial effects. In the LED array provided in embodiments of the present invention, an arrangement pattern in which alternate rows directly are aligned with each other is employed. When the LEDs work, no problem of moire pattern occurs when pictures are taken or videos are recorded by using various digital picture acquisition and video recording devices since no spatial interference takes place between the pixel layout in the LED display screen and the pixel layout in an image acquisition sensor of the picture acquisition and video recording devices, thereby avoiding the deformation and distortion of the image and ensuring the integrity of the picture and video information.

### BRIEF DESCRIPTION OF THE DRAWINGS

FIG. 1 is a schematic diagram showing the LED layout in an LED display screen provided in the prior art;

FIG. 2 is a schematic diagram showing the moire pattern provided in the prior art;

FIG. 3 is a schematic diagram showing the structure of a display system provided in an embodiment of the present invention;

FIG. 4 is a schematic diagram showing the structure of an LED module provided in an embodiment of the present invention;

FIG. 5 is a schematic diagram showing the LED layout provided in an embodiment of the present invention;

FIG. 6 is a diagram showing the principle of an LED light provided in an embodiment of the present invention;

FIG. 7 is a diagram showing the principle of a drive chip provided in an embodiment of the present invention; and

FIG. 8 is a diagram showing the principle of a power signal provided in an embodiment of the present invention.

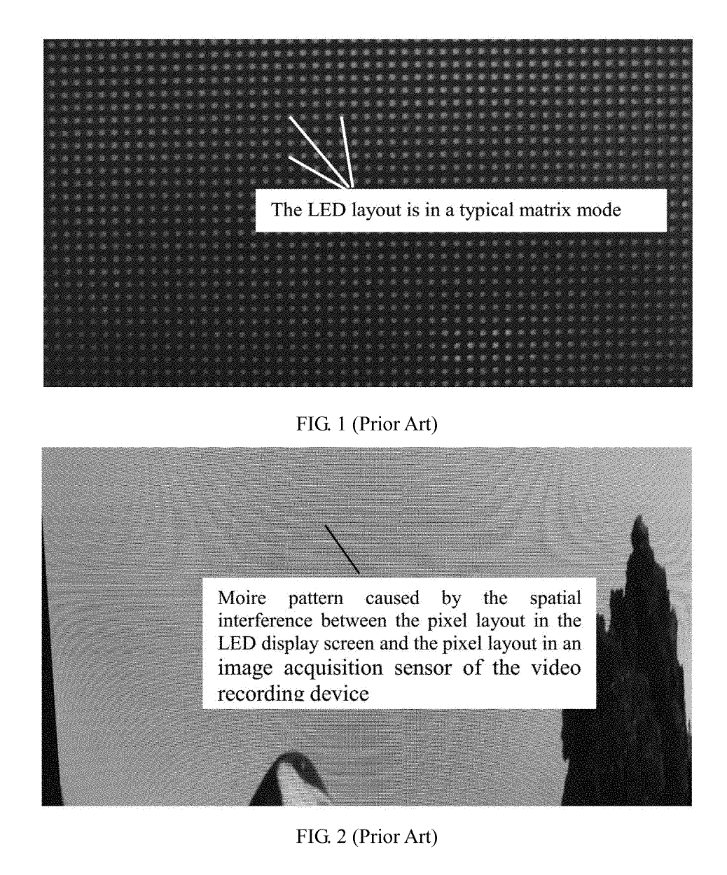

### DESCRIPTION OF THE EMBODIMENTS

In order to make the objects, technical solutions and advantages of the present invention more comprehensible, the present invention is further described in detail below with reference to the accompanying drawings and embodiments. It should be understood that the specific embodiments described herein are provided merely for explaining, instead of limiting the present invention.

In the prior art, the methods for eliminating the moire pattern associated with an LED display screen include the following.

1. Changing the angle of the camera. Since the angle of the camera with respect to an object may lead to a moire pattern, any moire pattern present may be eliminated or altered by slightly changing the angle of the camera (by rotating the camera).

2. Changing the position of the camera. The moire pattern may be additionally reduced by changing the angular relationship by moving left and right or up and down.

3. Changing the focus. A too sharp focus and highly delicate details on a fine picture may lead to a moire pattern, the sharpness can be changed by slightly changing the focus, thereby facilitating the elimination of moire pattern.

4. Changing the focal length of a lens. The moire pattern may be altered or eliminated by using different lens or focal length settings.

5. Using a filter before a lens. The filter is directly installed before CCD, such that the exposure condition satisfies the spatial frequency, thereby thoroughly filtering off the high spatial frequency portion from the image and reducing the occurrence of the moire pattern with the LED display, but this also reduces the sharpness of the image simultaneously LED display screen. However, this will also reduce the image sharpness simultaneously.

6. Processing with software. Any moire pattern occurring on a final image can be eliminated by processing with, for example, Photoshop.

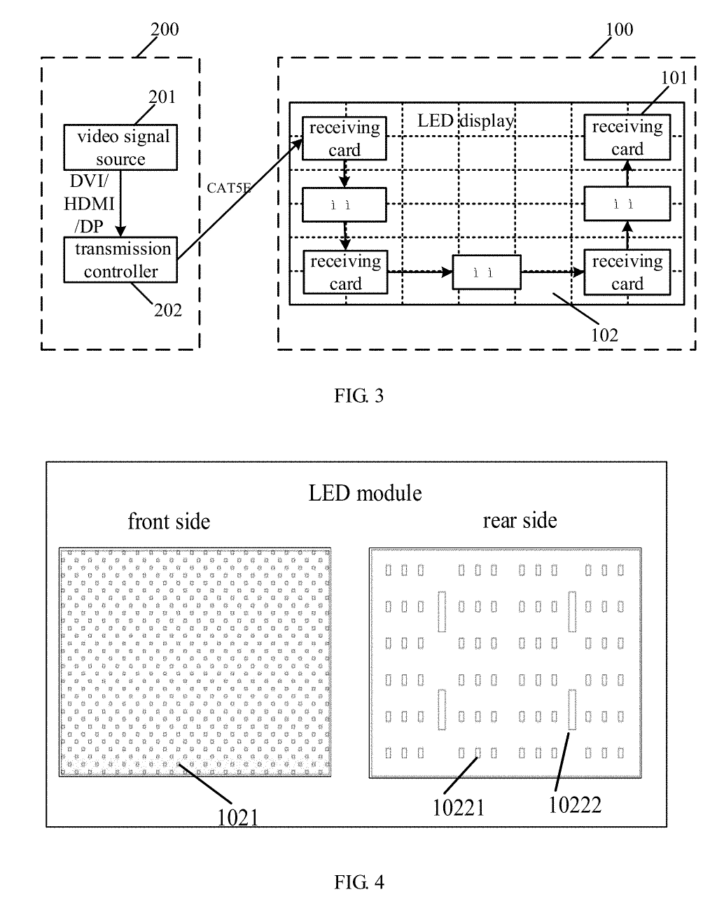

However, in the above solutions, the angle of the camera is needed to be set by a corresponding camera operator or corresponding processing with software is needed to be performed, which can not eliminate the moire pattern conveniently and promptly. In addition, the operator of the camera is required to have corresponding knowledge, which leads to a considerably compromised aesthetic feeling of a picture taken by an ordinary camera user. Based on this, FIG. 3 shows a display system provided in an embodiment of the present invention, which comprises an LED display screen 100 and a signal source unit 200.

The signal source unit 200 is configured to transmit a display signal to the LED display screen 100. Particularly, the signal source unit 200 comprises a video signal source 201 and a transmission controller 202. The video signal source 201 is configured to provide a video signal of a preset video format, and the transmission controller 202 is configured to convert the video signal into a display signal capable of being recognized and displayed by the LED screen 100, and transmit the display signal to the LED display screen 100. The video signal source 201 transmits the video signal to the transmission controller 202 via a digital visual interface (DVI), a high-definition multimedia interface (HDMI) or a high-definition digital display port (DP). The video signal source 201 provides a display content of a preset video format, and the display content on the LED display screen corresponds to the display content output from the video signal source 201 on a pixel-by-pixel basis. An interface via which the video signal source 201 outputs the display content is generally, for example, a DVI, HDMI, or DP interface. If an interface of other formats is used, a video processor inside the video signal source 201 converts the display content into a video signal of a video format corresponding to the above-mentioned 3 interfaces, and then transmits the converted video signal to the transmission controller 202. The transmission controller 202 functions to convert the video signal transmitted from the video signal source 201 into an information format capable of being received, recognized, and displayed by the LED display screen 100, and transmit the converted display signal to the LED display screen 100 in real time.

The LED display screen 100 is configured to display a corresponding content according to the display signal. Particularly, the LED display screen 100 comprises a plurality of LED modules 102 and a plurality of receiving cards 101. The receiving cards 101 are connected to the a plurality of LED modules 102, and configured to receive the display signal, convert the display signal into a serial digital signal, and then transmit the serial digital signal to the connected LED modules 102. The LED module 102 is configured to display according to the serial digital signal. The receiving card 101 functions to convert the received display signal into a serial digital signal by which the LED module 102 is able to be controlled, and transmit the serial digital signal to the LED module 102.

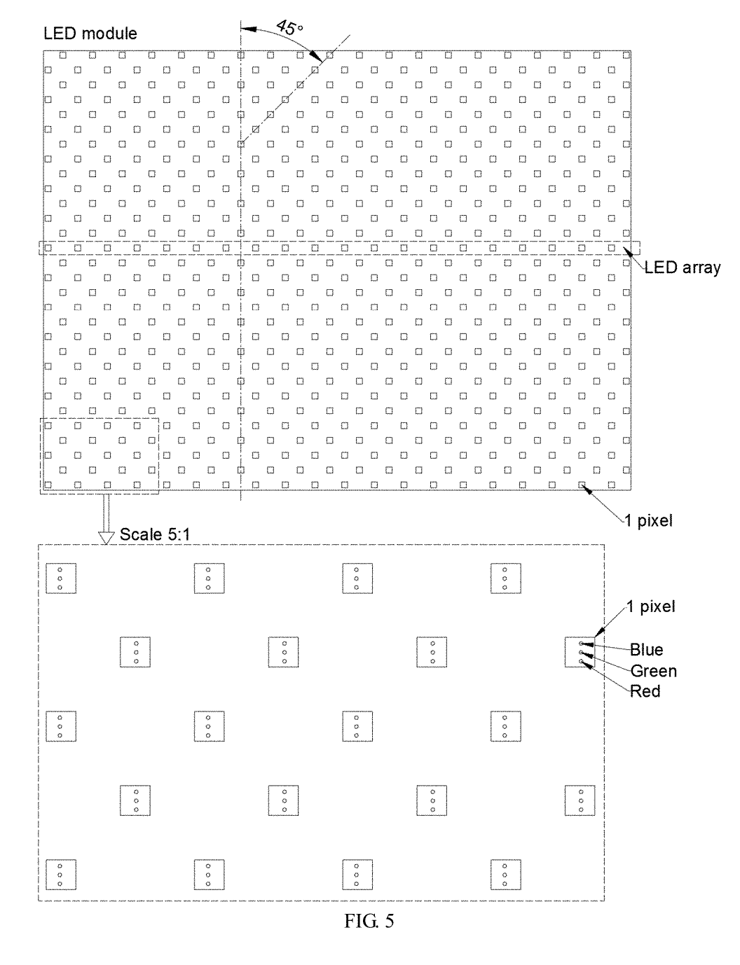

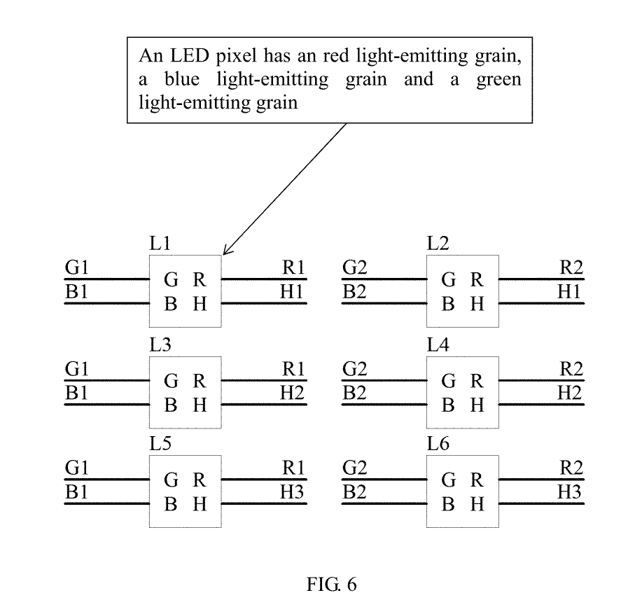

FIG. 4 shows the LED module 102 provided in an embodiment of the present invention, which comprises an LED array 1021 located on a front side and a control circuit 1022 located on a rear side and configured to drive the LED array 1021 to work. The LED array 1021 comprises a plurality of rows of LED units, and each row of the LED units comprises a plurality of LEDs disposed in sequence. Each of the LEDs is an LED pixel. As shown in FIG. 5 and FIG. 6, each of the LED pixels (1 pixel) integrates an red light-emitting grain, a blue light-emitting grain and a green light-emitting grain.

The LED array 1021 is arranged in such a pattern that alternate rows are aligned with 20 each other, in which LEDs of the same sequence number in all the odd rows of the LED units are aligned in a same vertical direction, LEDs of the same sequence number in all the even rows of the LED units are aligned in a same vertical direction, and LEDs of the same sequence number in adjacent two rows of the LED units are deviating one another in a vertical direction, thereby forming a structure in which LEDs in each row of the LED units are arranged deflecting from respective LEDs in an adjacent row of the LED units. In practical applications, for facilitating the product design and the layout of a circuit board, a connecting line between LEDs of the same sequence number in adjacent two rows of the LED units is at 45 degrees with respect to the vertical direction. The particular arrangement of the LED units is as shown in FIG. 5, and the principle of an LED light is as shown in FIG. 6. When the LED array of an LED display comprises the plurality of rows of LED units, and each row of the LED units comprises the plurality of LED pixels integrating the red light-emitting grain, the blue light-emitting grain and the green light-emitting grain, if the LED array of the LED display is a matrix array of the prior art, the spatial interference between the pixel layout in the LED display screen and the pixel layout in an image acquisition sensor of the picture acquisition and video recording device is formed easily when the LED display is shot by using a camera, a camcorder, or other picture acquisition and video recording devices. However, no spatial interference takes place between the pixel layout in the LED display screen and the pixel layout in an image acquisition sensor of a picture acquisition and video recording device, base on the structure in which LED pixels in each row of the LED units is arranged deflecting from respective LED pixels in an adjacent row of the LED units.

The control circuit 1022 is configured to convert a received serial digital signal into a parallel display signal by which the LEDs is controlled to turn on/off. Particularly, the control circuit 1022 comprises a drive module 10221 and an interface module 10222. The drive module 10221 is connected to a pin of each LED and configured to convert the received serial digital signal into a parallel display signal by which the LEDs is controlled to on/off. The interface module 10222 is configured to receive a serial digital signal and a DC power signal for supplying power to the drive module 10221, and transmit the serial digital signal to the drive module 10221.

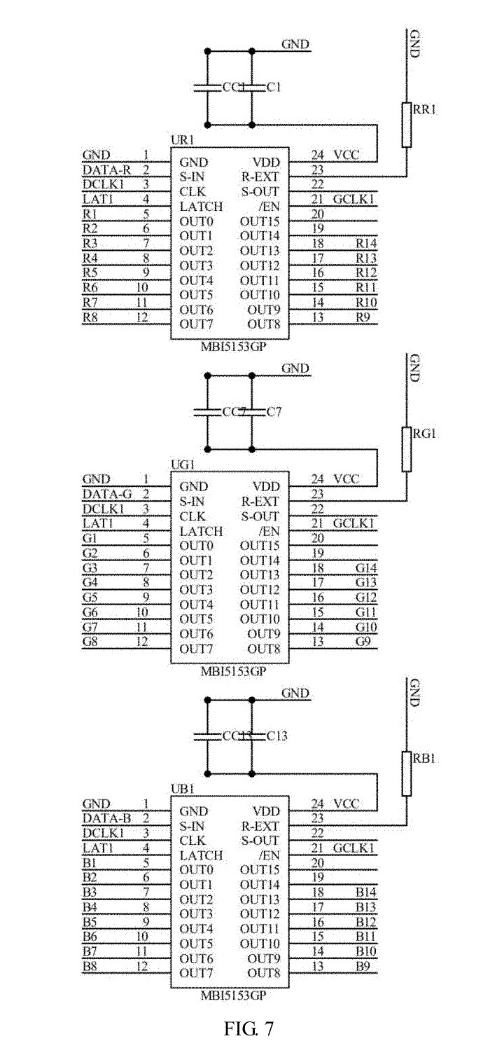

FIG. 7 is a diagram showing the principle of the drive module 10221. The drive module 10221 comprises a control chip and a peripheral circuit thereof. The drive module 10221 converts the serial digital signal transmitted from the receiving card 101 into a parallel display signal, and the parallel display signal is coupled to the pin of the LED to control the on/off of the LED, thereby achieving the purpose of displaying the display content output from the video signal source.

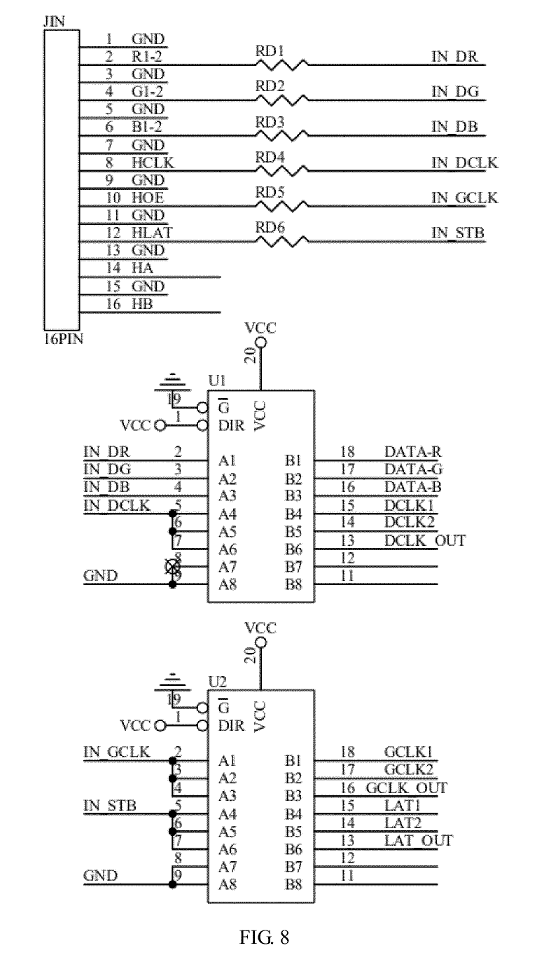

FIG. 8 is a diagram showing the principle of the interface module 10222. The interface module 10222 transmits the serial digital signal and a DC power signal via a gold finger on the interface to the drive module 10221. The DC power signal supplies power to the drive module 10221 to enable the drive module 10221 to work normally, and the serial digital signal is driven by a data transceiver built in the interface module to be provided to the drive module.

In the LED array provided in embodiments of the present invention, an arrangement pattern in which alternate rows are aligned with each other is employed, in which LEDs of the same sequence number in adjacent two rows of the LED units are deviating one another in a vertical direction, thereby forming a structure in which LEDs in each row of the LED units is arranged deflecting from respective LEDs in an adjacent row of the LED units. As a result, no spatial interference takes place between the pixel layout in the LED display screen and the pixel layout in an image acquisition sensor of a picture acquisition and video recording device, thereby solving the problem of moire pattern associated with an LED display screen. In particular applications, for facilitating the arrangement of LEDs and the circuit design, a connecting line between LEDs of the same sequence number in adjacent two rows of the LED units is at 45 degrees with respect to the vertical direction. However, other angles may be used in practical applications.

By adopting the LED display screen provided in the embodiments of the present invention, the problem of moire pattern occurring during the shooting process by a camera or a camcorder is solved. The LED display screen is widely applicable to the recording of live broadcasted and rebroadcasted programs in the studio of TV station and of sport games and stage performances, video conference rooms, large-scale monitoring centers, and other areas. During the use of the LED display screen provided in the embodiments of the present invention, no problem of moire pattern occurs when pictures are taken or videos are recorded by using various digital picture acquisition and video recording devices, thereby avoiding the deformation and distortion of the image and ensuring the integrity of the picture and video information. This further contributes to the wide application of the LED display screen in various areas.

Preferred embodiments of the present invention have been described hereinbefore;

however, the present invention is not limited thereto. Any changes, equivalent replacements and improvements made without departing from the spirit and principles of the present invention are intended to be embraced in the protection scope of the present invention.

What is claimed is:

1. An LED module, comprising an LED array and a control circuit for driving the LED array to work, wherein the LED array comprises a plurality of rows of LED units, each row of the LED units comprises a plurality of LED pixels disposed in sequence, each of the LED pixels integrates an red light-emitting grain, a blue light-emitting grain and a green light-emitting grain;
the LED array is arranged in such a pattern that alternate rows are aligned with each other, in which LED pixels of the same sequence number in all odd rows of the LED units are aligned in a same vertical direction, LED pixels of the same sequence number in all even rows of the LED units are aligned in a same vertical direction, and LED pixels of the same sequence number in adjacent two rows of the LED units are deviating one another in a vertical direction, thereby forming a structure in which LED pixels in each row of the LED units are arranged deflecting from respective LED pixels in an adjacent row of the LED units; and
the control circuit is configured to convert a received serial digital signal into a parallel display signal by which the LED pixels is controlled to turn on/off.

2. The LED module according to claim 1, wherein a connecting line between LED pixels of the same sequence number in adjacent two rows of the LED units is at 45 degrees with respect to the vertical direction.

3. The LED module according to claim 1, wherein the control circuit comprises a drive module and an interface module, wherein
the interface module is configured to receive the serial digital signal and a DC power signal, transmit the DC power signal via a gold finger on the interface to the drive module for supplying power to the drive module, and provide the serial digital signal to the drive module by a data transceiver built in the interface module; and
the drive module is connected to the interface module and a pin of each LED, and configured to convert the received serial digital signal into a parallel display signal by which the LED pixels are controlled to turn on/off.

4. The LED module according to claim 2, wherein the LED array is located on a front side and the control circuit is located on a rear side.

5. An LED display screen, comprising a plurality of LED modules according to claim 1 and a plurality of receiving cards, wherein
the receiving cards are connected to the a plurality of LED modules, and configured to receive a display signal, convert the display signal into the serial digital signal, and transmit the serial digital signal to the connected LED modules; and
the LED module is configured to display according to the serial digital signal.

6. A display system, comprising an LED display screen according to claim 4 and a signal source unit, wherein
the signal source unit is configured to transmit the display signal to the LED display screen; and
the LED display screen is configured to display a corresponding content according to the display signal.

7. The display system according to claim 6, wherein the signal source unit comprises a video signal source and a transmission controller, in which
the video signal source is configured to provide a video signal of a preset video format; and
the transmission controller is configured to convert the video signal into the display signal capable of being recognized and displayed by the LED screen, and transmit the display signal to the LED display screen.

8. The display system according to claim 7, wherein the video signal source is configured to transmit the video signal to the transmission controller via a digital visual interface, a high-definition multimedia interface or a high-definition digital display port.

9. The display system according to claim 8, wherein the display content on the LED display screen corresponds to the display content output from the video signal source on a pixel-by-pixel basis.

10. The display system according to claim 8, wherein the video signal source further comprises a video processor configured to convert the display content into a video signal of a video format corresponding to the digital visual interface, the high-definition multimedia interface or the high-definition digital display port, and transmit the converted video signal to the transmission controller.
